(19) United States
(12) Patent Application Publication
(10) Pub. No.: US 2013/0024411 A1
(43) Pub. Date: Jan. 24, 2013

(54) Discovery of Vegetation over the Earth (DOVE)

(71) Applicants: Dongming Michael Cai, Los Alamos, NM (US); Nathan Gabriel McDowell, Los Alamos, NM (US)

(72) Inventors: Dongming Michael Cai, Los Alamos, NM (US); Nathan Gabriel McDowell, Los Alamos, NM (US)

(21) Appl. No.: 13/175,242

(22) Filed: Jul. 18, 2011

(51) Int. Cl. G06N 5/02

(52) U.S. Cl. 706/46

(57) ABSTRACT

A system, apparatus and method for identifying states or types of individual objects within a class of objects of interest are provided. A supervised algorithm is executed on a set of map data to separate a class of objects of interest from other objects. An unsupervised algorithm is executed to identify different types or states of individual objects within the class of objects of interest identified by the supervised algorithm. The results are then stored on a non-transitory storage medium.

### STATEMENT OF FEDERAL RIGHTS

The United States government has rights in this invention pursuant to Contract No. DE-AC52-06NA25396 between the United States Department of Energy and Los Alamos National Security, LLC for the operation of Los Alamos National Laboratory.

### BACKGROUND

1. Field

The present invention generally relates to analyzing map data. More specifically, the present invention relates to identifying states or types of individual objects within a class of objects of interest.

2. Description of the Related Art

Today, about a trillion (10¹²) canopy trees on Earth consist of around 100,000 species. These trees store about as much carbon dioxide (CO₂) as is currently in the atmosphere. Trees play a critical role in absorbing terrestrial CO₂ and keeping CO₂ at an appropriate level suitable for human beings to live on Earth. Recently, studies have indicated that tree mortality is increasing in many regions. However, there is no capability currently available to monitor vegetation changes and correlate and predict tree mortality with CO₂ changes and climate change on a global scale.

### SUMMARY

Certain embodiments of the present invention may provide solutions to the problems and needs in the art that have not yet been fully solved by conventional mapping systems and methods. For example, certain embodiments of the present invention identify states or types of individual objects within a class of objects of interest.

In one embodiment of the present invention, a computer program is embodied on a non-transitory computer-readable medium. The program is configured to cause a processor to execute a supervised algorithm on a set of map data to separate a class of objects of interest from other objects. The program is also configured to cause the processor to execute an unsupervised algorithm to identify different types or states of individual objects within the class of objects of interest identified by the supervised algorithm. The program is further configured to cause the processor to cause results produced by the unsupervised algorithm to be stored on a non-transitory storage medium.

In another embodiment of the present invention, an apparatus includes physical memory and a processor configured to read information from, and write information to, the physical memory. The processor is configured to execute a supervised algorithm on a set of map data to identify and separate trees from other terrestrial objects. The processor is also configured to execute an unsupervised algorithm, using tree data produced by the supervised algorithm, to assess tree health. The processor is further configured to determine warning signs of tree mortality based on results produced by the unsupervised algorithm. Additionally, the processor is configured to cause data pertaining to the warning signs of tree mortality to be stored on the physical memory.

In yet another embodiment of the present invention, a computer-implemented method includes executing, via a processor, a supervised algorithm on a set of map data to identify and separate a class of objects of interest from other objects. The computer-implemented method also includes executing, via the processor, an unsupervised algorithm to identify different types or states of individual objects within the class of objects of interest identified by the supervised algorithm. The computer-implemented method further includes storing results produced by the unsupervised algorithm on a non-transitory storage medium. The supervised and unsupervised algorithms are configured to use three color bands to separate the class of objects of interest and to determine the types or states of the individual objects within the class of objects of interest.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 illustrates a system for identifying states or types of individual objects within a class of objects of interest, according to an embodiment of the present invention.

FIG. 2 illustrates a flowchart of a method for identifying class objects and object features, according to an embodiment of the present invention.

FIG. 3A illustrates an unmodified grayscale image of an area captured by satellite imagery, according to an embodiment of the present invention.

FIG. 3B illustrates a grayscale image of an area captured by satellite imagery after a supervised algorithm has been applied, according to an embodiment of the present invention.

FIG. 4 illustrates a flowchart of a method for identifying class objects and object features, according to an embodiment of the present invention.

FIG. 5 illustrates a flowchart of a method for separating trees from other terrestrial objects and assessing tree health, according to an embodiment of the present invention.

FIG. 6 illustrates a flowchart of a method for identifying class objects and object features, according to an embodiment of the present invention.

FIG. 7 illustrates a flowchart of a Minimum Distance algorithm used for supervised learning, according to an embodiment of the present invention.

FIG. 8 illustrates a flowchart of an Iterative Self-Organizing Data Analysis Technique Algorithm (ISODATA) used for unsupervised learning, according to an embodiment of the present invention.

### DETAILED DESCRIPTION

It will be readily understood that the components of various embodiments of the present invention, as generally described and illustrated in the figures herein, may be arranged and designed in a wide variety of different configurations. Thus, the following more detailed description of the embodiments of the systems, apparatuses and methods of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

Some embodiments of the present invention leverage a two-stage process to analyze map data using a supervised algorithm and then an unsupervised algorithm. More specifically, a supervised algorithm is first used to identify objects of interest that belong to a certain class and to separate the objects of interest from other terrestrial objects. For instance, it is possible to distinguish trees from rocks, roads, buildings, and other terrain features, whether manmade or natural. An unsupervised algorithm is then used to analyze the objects of interest identified by the supervised algorithm and then to ascertain certain characteristics about these objects. For instance, where the objects of interest are trees, it is possible in some embodiments to identify the types of individual trees, as well as whether trees are healthy, stressed or dead. Embodiments of the present invention may have applications such as determining warning signs of tree mortality, performing crop assessments, assessing land use and performing fire damage assessments. However, it should be recognized that the applications are not limited to those enumerated above and may be used for any purpose involving classifying, and determining characteristics of, objects of interest that are present in map data.

Different survey platforms have been used for forest management. Typical ground-based forest surveys measure tree stem diameter, tree species, and whether each tree is alive or dead. The measurements in this approach are low-tech and time consuming, but the sample sizes are large, running into millions of trees, covering large areas, and spanning many years. These field surveys provide powerful ground validation for other survey methods such as photo surveys, helicopter global positioning system (GPS) surveys, and aerial overview surveys.

Dynamic global vegetation models (DGVMs), a recent advance in forest modeling, simulate the distribution, physiology and biogeochemistry of trees and other vegetation at global scales. These DGVMs are useful in attempting to predict the future regional and global climate because of the critical role that vegetation plays in regulating the lower boundary layer of the atmosphere. Current DGVMs suggest that global forest carbon storage is a key parameter in the response of Earth's climate system to anthropogenic CO₂ emissions over the next century. However, the predictions of the DGVMs on land uptake (absorption) of CO₂ are surprisingly different. This makes vegetation dynamics one of the largest sources of uncertainty in Earth system models. Because of a lack of data or theory, current DGVMs reduce biodiversity (over 100,000 tree species) to a small number of plant functional types (PFTs) within which all parameters are constant. Under this “top down” approach, accuracy is suboptimal.

Satellite imagery has a much larger area of coverage than other imagery mechanisms, and it is generally easier to tile the different images together. More importantly, the spatial resolution has been improved to levels that are close to, or in some cases even higher than, the spatial resolution levels of aerial survey platforms. Today, satellite data has reached sub-meter spatial resolution for panchromatic channels (for instance, lm for IKONOS 2 and 0.61 m for Quickbird-2) and meter spatial resolution for multi-spectral channels (for instance, 4 m for IKONOS 2 and 2.44 m for Quickbird-2). Accordingly, high resolution satellite imagery can allow foresters to discern individual trees. This vital information should allow physiological states of trees to be quantified. In other words, it should be possible to discern whether trees are healthy or dead, the shape and size of tree crowns, and the species and functional compositions of trees. Satellite data thus presents a potentially powerful data resource. However, due to the vast amount of data collected daily (for example, Quickbird-2 collects around 7-11 terabits per day), it is impossible for human analysts to review the imagery in detail to identify vital biodiversity information.

Detection and classification of stress and tree mortality down to individual trees on the Earth would bring a major breakthrough in regional and global vegetation modeling, which is a critical component of, and one of the largest uncertainties in, understanding and predicting the global vegetation response to climate change. Accordingly, some embodiments of the present invention identify the composition and stress levels of individual trees from high resolution satellite imagery, or map data. This “bottom up” approach yields unprecedented accuracy with respect to spatial, temporal and mechanistic data.

Some embodiments of the present invention leverage both supervised and unsupervised learning algorithms, and the performance of this new classification system has shown impressive accuracy in identifying the vegetation from the background in map data, and in distinguishing healthy, stressed and dead trees. The information may then be aggregated into mechanistic plant functional type (PFT) patches at spatial scales appropriate for modeling, and the method may be scaled up to account for the distribution of trees on a global scale. The capability to enable analysis and classification of individual trees represents a major breakthrough in regional and global vegetation monitoring and modeling.

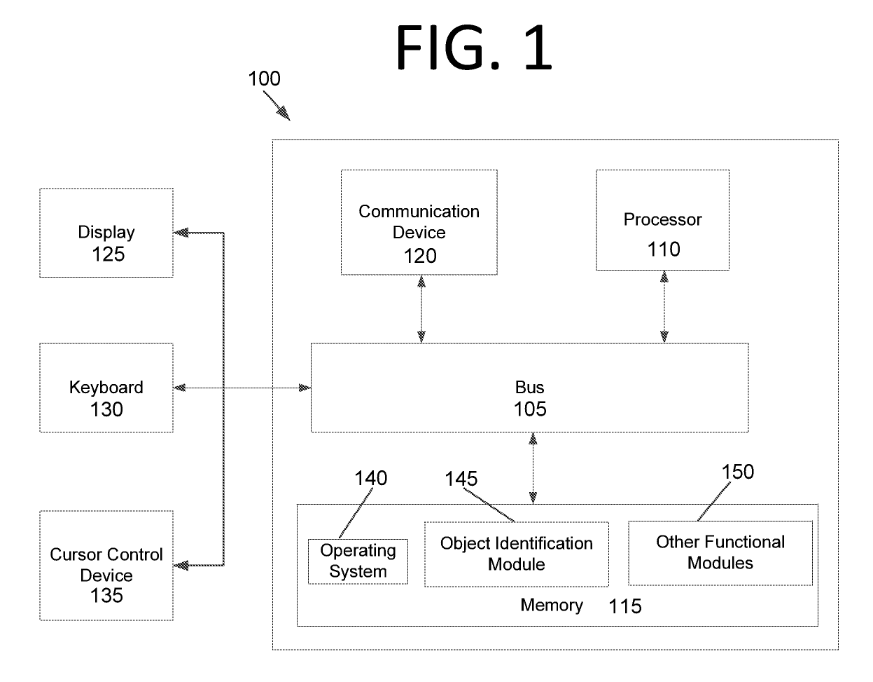

FIG. 1 illustrates a system 100 for identifying states or types of individual objects within a class of objects of interest, according to an embodiment of the present invention. System 100 includes a bus 105 or other communication mechanism for communicating information, and a processor 110 coupled to bus 105 for processing information. Processor 110 may be any type of general or specific purpose processor, including a central processing unit (CPU) or application specific integrated circuit (ASIC). System 100 further includes a memory 115 for storing information and instructions to be executed by processor 110. Memory 115 can be comprised of any combination of random access memory (RAM), read only memory (ROM), flash memory, cache, static storage such as a magnetic or optical disk, or any other types of non-transitory computer-readable media or combinations thereof. Additionally, system 100 includes a communication device 120, such as a wireless network interface card, to provide access to a network.

Non-transitory computer-readable media may be any available media that can be accessed by processor 110 and may include both volatile and non-volatile media, removable and non-removable media, and communication media. Communication media may include computer-readable instructions, data structures, program modules or other data in a modulated data signal such as a carrier wave or other transport mechanism and includes any information delivery media.

Processor 110 is further coupled via bus 105 to a display 125, such as a Liquid Crystal Display (“LCD”), for displaying information, such as a numerical representation of garment size measurements, to a user. A keyboard 130 and a cursor control device 135, such as a computer mouse, are further coupled to bus 105 to enable a user to interface with system 100.

In one embodiment, memory 115 stores software modules that provide functionality when executed by processor 110. The modules include an operating system 140 for system 100. The modules further include an object identification module 145 that is configured to identify states or types of individual objects within a class of objects of interest. System 100 may include one or more additional functional modules 150 that include additional functionality.

One skilled in the art will appreciate that a “system” could be embodied as a personal computer, a server, a console, a personal digital assistant (PDA), a cell phone, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

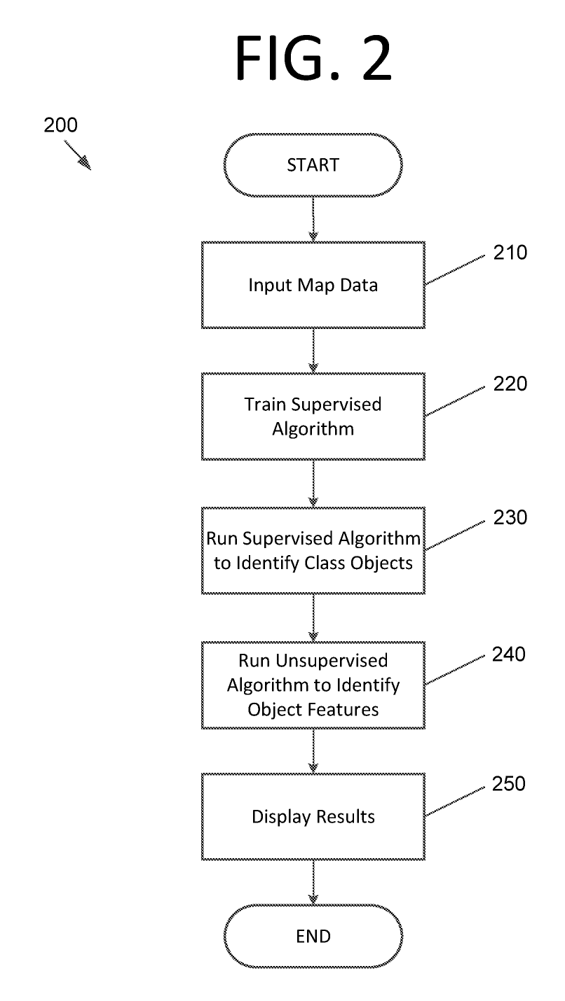

FIG. 2 illustrates a flowchart 200 of a method for identifying class objects and object features, according to an embodiment of the present invention. First, map data, such as satellite imagery data, is input into a computer system at 210. In some embodiments, the computer system may be system 100 of FIG. 1, for instance. The map data may be on the order of terabytes or larger, and may be so large as to be impractical or impossible for individuals to analyze without computer assistance.

Next, a supervised algorithm is trained at 220. Supervised learning can be used to cluster pixels in a map data set into classes corresponding to user-defined training classes. Supervised learning generally requires the user to select regions of interest (ROIs) in the training data set as the basis for classification. Various methods are then applied to determine if a specific pixel qualifies as a class member, such as examining pixel color.

An example of a supervised algorithm is a Minimum Distance algorithm. The minimum distance classification uses the mean vectors of each selected ROI and calculates the Euclidean distance from each unknown pixel to the mean vector for each class. All pixels are classified to the closest ROI class unless the user specifies standard deviation or distance thresholds, in which case some pixels may be unclassified if they do not meet the selected criteria. The Minimum Distance algorithm has shown better results in certain tests than Maximum Likelihood and Support Vector Machine algorithms.

Supervised learning occurs when a user knows what objects to look for, and “trains” the algorithm by marking objects of interest. For example, a user who wishes for the supervised algorithm to identify and separate trees from other objects present in map data (such as rocks, roads and buildings) may mark the trees on a map. The algorithm then determines a “spectral/structural signature” for the marked objects (in this case, trees). A spectral signature is a unique combination of bands (e.g., red, blue and green values) which represent the object of interest. A structural signature generally pertains to the characteristic shape, size, etc. Either a spectral signature, a structural signature, or both, may be used.

The supervised algorithm then uses the determined characteristics to identify a class of objects from the map data at 230. For instance, in the context of identifying trees, the supervised algorithm may identify and separate trees from other terrestrial objects such as roads, buildings, rocks, etc. The trees would constitute a class of “positive examples” and the other structures would constitute a class of “negative examples”. Ideally, the supervised algorithm maximizes the differences between the two classes to achieve an optimal separation.

The set of positive class objects is then used by an unsupervised algorithm at 240 to identify and extract various features, such as the types, number, density, and characteristics of the objects in the class. In the case of trees or other objects, the primary features could be the differences among tree species in terms of edge, color, texture, geometry and other secondary features. An example of an unsupervised algorithm is the Iterative Self-Organizing Data Analysis Technique Algorithm (ISODATA). The ISODATA unsupervised algorithm calculates class means evenly distributed in the data and then iteratively clusters the remaining pixels using minimum distance techniques. Each iteration recalculates means and reclassifies pixels with respect to the newly calculated means. This process continues until the number of pixels in each class changes by less than the selected pixel change threshold or the maximum number of iterations is reached.

In the context of identifying trees, profiles for tree types may be used. These profiles may include information such as edge, color, texture and geometry features, as well as other features that distinguish between tree species. The profiles may also take into account changes in tree appearance throughout the year. For example, a live maple tree looks different when it has no leaves in the winter, buds and growing leaves in the spring, fully grown leaves in the summer, and dying leaves in the fall. Different data fusion schemes may be used to classify the tree species and capitalize on seasonal effects. In one scheme, the features extracted from the imagery in different seasons will be mixed together, and the classifier will more heavily weigh invariant features such as tree shape (structural signature) or the combination of colors (spectral signature) to identify maple trees, but will also include, but deemphasize, color as a 2^{nd} level identifier. A second classifier constructs and applies individual species profiles for different seasons. This allows identification and exploitation of temporal variation associated with time (seasonal, growth, stress, and mortality information), while allowing accurate identification of tree species. The spectral signature, or color bands, have demonstrated the capability to identify trees and their status (i.e., live vs. dead) with a high degree of accuracy. The use of structural signatures (e.g., edge, shape, and texture) may also profile trees well, and may be even more effective when used in combination with the spectral signature.

The unsupervised algorithm may determine the types of trees, how many trees of each type are present, the density of trees, and whether trees are healthy, stressed or dead. Since the number of tree species is quite large, using unsupervised learning will avoid the need to build a large number of classifiers, which is O(N²) in “big oh” notation, where N is the number of classifiers. Another advantage is that the features selected by unsupervised learning algorithms are unique to the individual tree species, not the differences among the tree species as with supervised algorithms.

In general, supervised algorithms achieve better performance than the unsupervised algorithms. However, this novel two-stage approach benefits from the advantages of both the supervised and the unsupervised algorithms and achieves better performance than either method individually.

Finally, the results of the analysis are displayed to a user at 250. The user may see data graphically, be presented with various statistics, or both. For example, in some embodiments, the user may be presented with an image that shows healthy trees, stressed trees and dead trees in different colors. The user may also be able to toggle the view to see different tree species in different colors. The display may indicate to the user the number of trees of each type, tree density information, the number of healthy, stressed and dead trees, etc. Testing has shown that the data obtained by this method is highly accurate when verified with ground survey data.

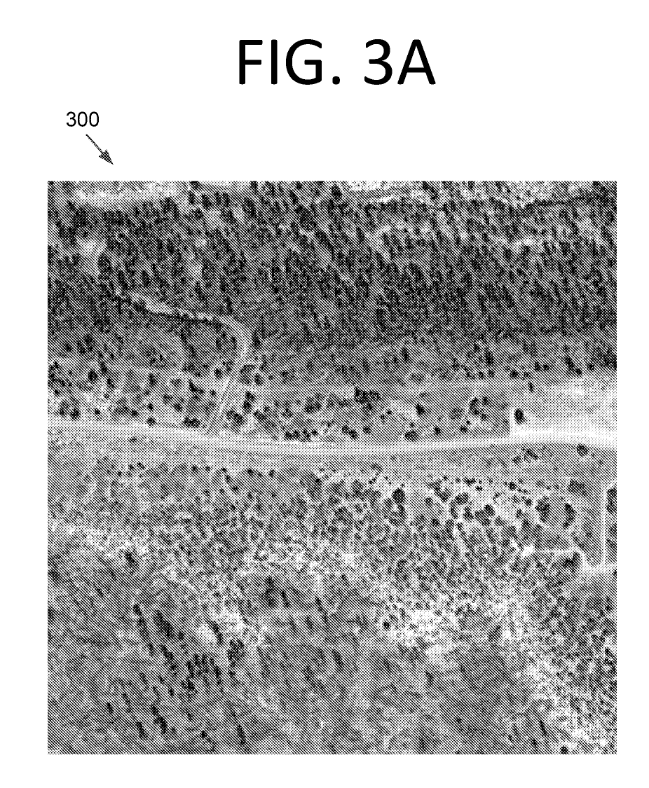

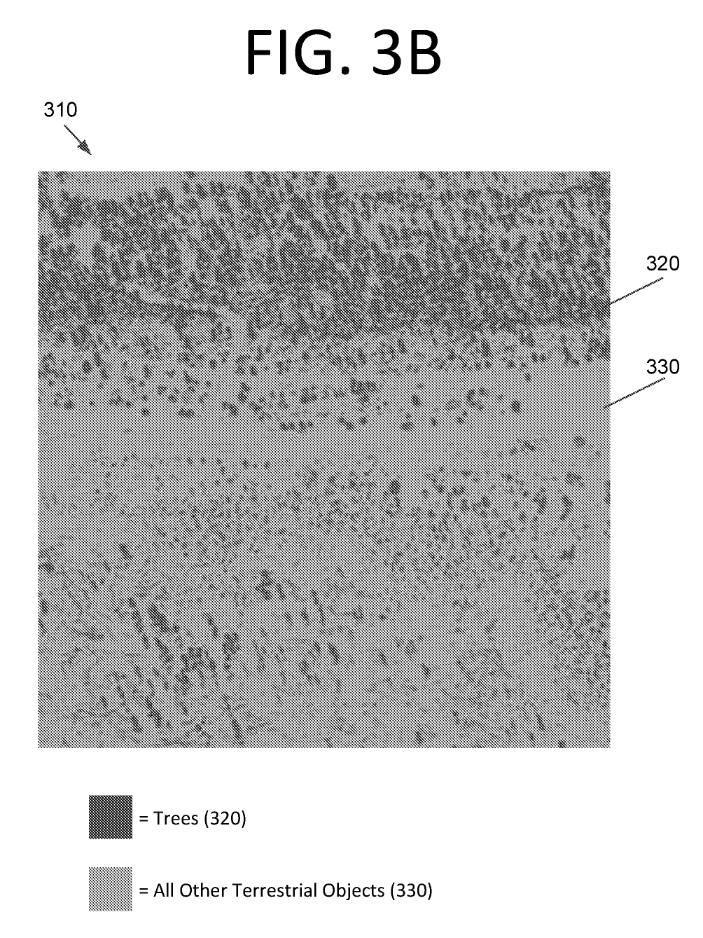

FIG. 3A illustrates an unmodified grayscale image 300 of an area captured by satellite imagery, according to an embodiment of the present invention. While the images herein are shown in grayscale for formalities purposes, in practice, color information and other mapping information may be present. As can be seen, the image includes various terrain features, such as trees and a road running through the middle of the image.

FIG. 3B illustrates a grayscale image 310 of an area captured by satellite imagery after a supervised algorithm has been applied, according to an embodiment of the present invention. As can be seen, the image has been altered such that only two colors of features stand out. The dark gray features 320 represent trees and the light gray features 330 represent everything else. Thus, the supervised algorithm has separated the terrain features present in the map into two classes: 1) trees; and 2) everything else.

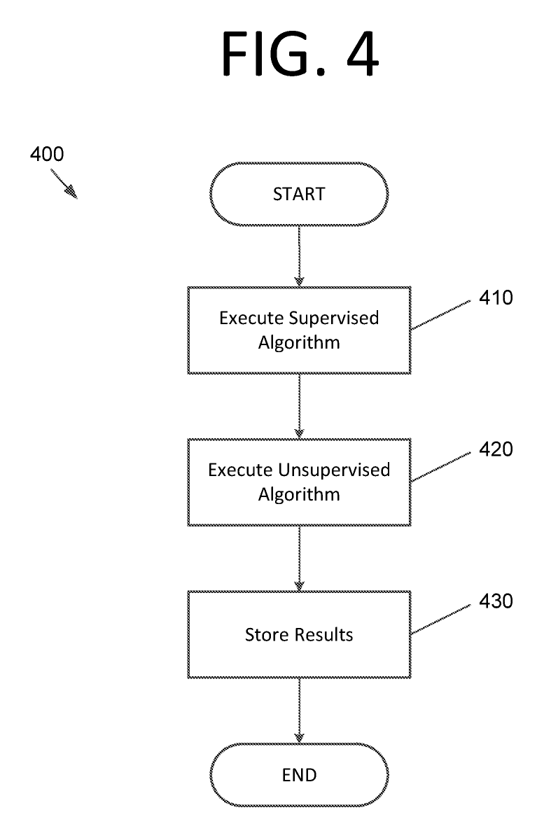

FIG. 4 illustrates a flowchart 400 of a method for identifying class objects and object features, according to an embodiment of the present invention. The method may be performed, for example, by a computer system such as system 100 of FIG. 1. The method may be used, for example, to determine warning signs of tree mortality, perform crop assessments, assess land use, perform fire damage assessments, etc.

First, a supervised algorithm is executed on a set of map data to separate a class of objects of interest from other objects at 410. The map data may be, for example, satellite imagery data. The supervised algorithm may be a Minimum Distance algorithm in some embodiments. The supervised algorithm may use both positive and negative examples to identify, and maximize differences between, two classes of objects.

Next, an unsupervised algorithm is executed to identify different types or states of individual objects within the class of objects of interest identified by the supervised algorithm at 420. The unsupervised algorithm may be an ISODATA algorithm, for example. The unsupervised algorithm may use only the class with positive examples or only the class with negative examples in some embodiments. When examining trees, the supervised algorithm may be configured to separate trees from other terrestrial objects and the unsupervised algorithm may be configured to assess tree health. The results produced by the unsupervised algorithm are then stored on a non-transitory storage medium at 430, such as a hard disk, flash memory, or any other suitable non-transitory storage device.

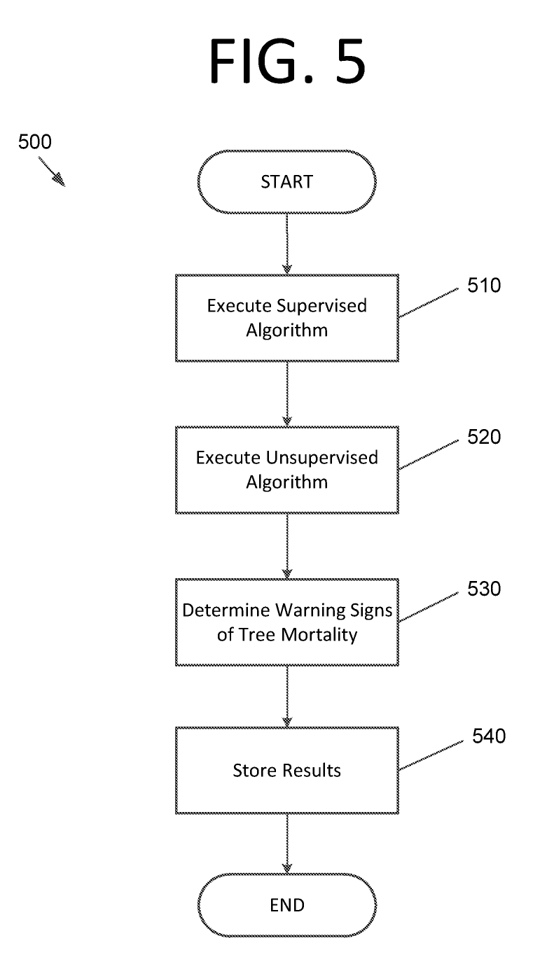

FIG. 5 illustrates a flowchart 500 of a method for separating trees from other terrestrial objects and assessing tree health, according to an embodiment of the present invention. The method may be performed, for example, by a computer system such as system 100 of FIG. 1. First, a supervised algorithm is executed on a set of map data to identify and separate trees from other terrestrial objects at 510. Then, an unsupervised algorithm, using tree data produced by the supervised algorithm, is executed at 520 to assess tree health. Next, warning signs of tree mortality are determined based on results produced by the unsupervised algorithm at 530. The warning signs may be determined by identifying levels of stress on individual trees, such as healthy, stressed and dead. Finally, data pertaining to the warning signs of tree mortality is stored on physical memory at 540.

The unsupervised algorithm may determine different types of individual trees based on profiles for tree types. The profiles may include factors such as edge, color, texture and geometry information. The tree types may also take into account changes in tree appearance throughout the year.

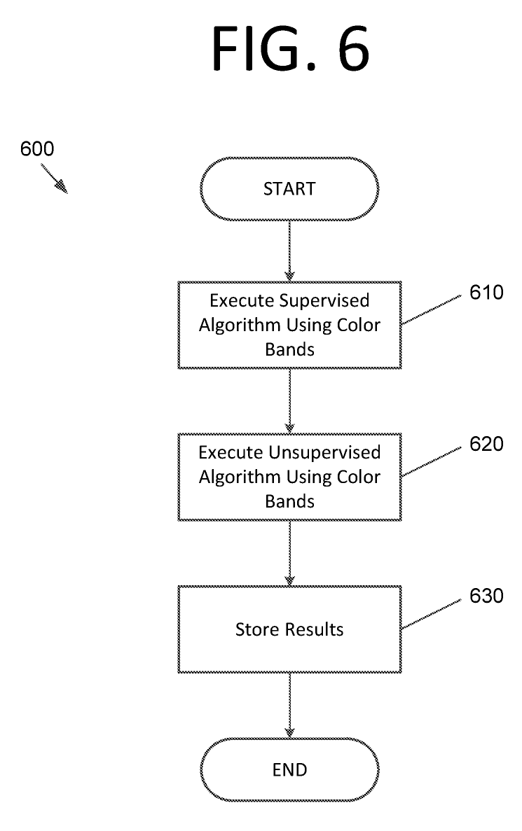

FIG. 6 illustrates a flowchart 600 of a method for identifying class objects and object features, according to an embodiment of the present invention. The method may be performed, for example, by a computer system such as system 100 of FIG. 1. A supervised algorithm is executed on a set of map data to identify and separate a class of objects of interest from other objects at 610. The supervised algorithm uses multiple color bands to separate the objects of interest in the class from other objects. In some embodiments, the algorithm may use multiple color bands, such as red, green and blue. In certain data sets, the overall classification accuracy of the minimal distance algorithm in some embodiments has been validated at about 95% accuracy. Some embodiments may not need to make use of one or more infrared bands.

Unsupervised learning can be used to cluster pixels in a data set based on statistics only, without any user-defined training classes. In this embodiment, the unsupervised algorithm is then executed to identify different types or states of individual objects within the class of objects of interest identified by the supervised algorithm at 620. The unsupervised algorithm also makes use of multiple color bands to perform its operations. The results produced by the unsupervised algorithm are then stored on a non-transitory storage medium at 630.

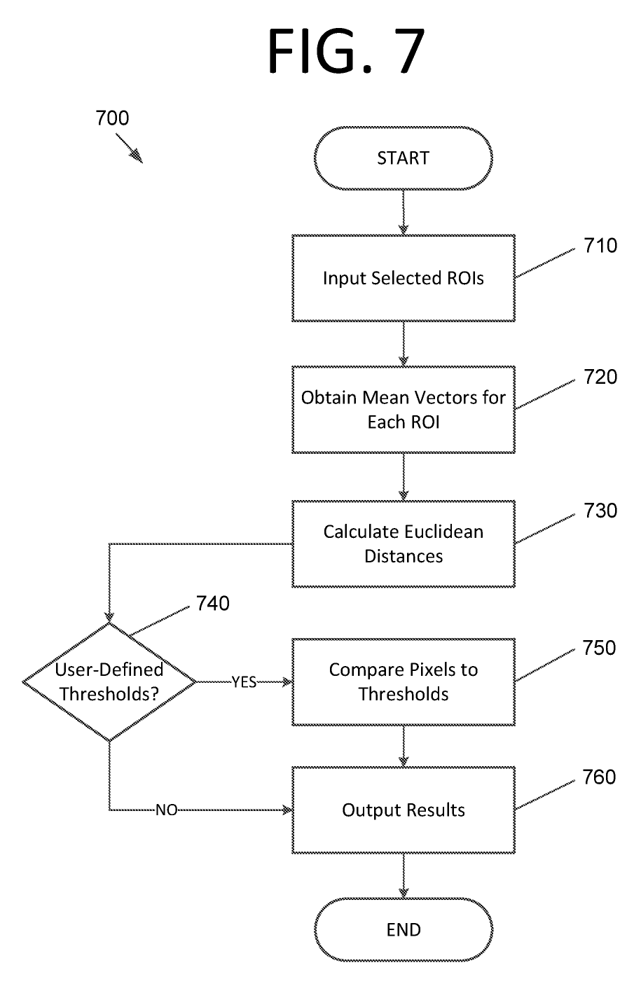

FIG. 7 illustrates a flowchart 700 of a Minimum Distance algorithm used for supervised learning, according to an embodiment of the present invention. The Minimum Distance algorithm may be performed, for example, by a computer system such as system 100 of FIG. 1. First, one or more regions of interest (ROIs) that a user has selected are input at 710. These ROIs from a training data set serve as the basis for classification of objects. Next, mean vectors are obtained for each ROI at 720. The Minimum Distance algorithm then calculates the Euclidean distance from each unknown pixel to the mean vector for each class at 730.

If user-specified thresholds are being applied at 740, such as standard deviation or distance thresholds, the pixels are classified to the closest ROI class. If user-specified thresholds are being applied at 740, pixels are compared to the selected criteria at 750. If the pixels meet the selected criteria, they are classified to the closest ROI class. If the pixels do not meet the selected criteria, they are unclassified. The results generated by the Minimum Distance algorithm are then output at 760.

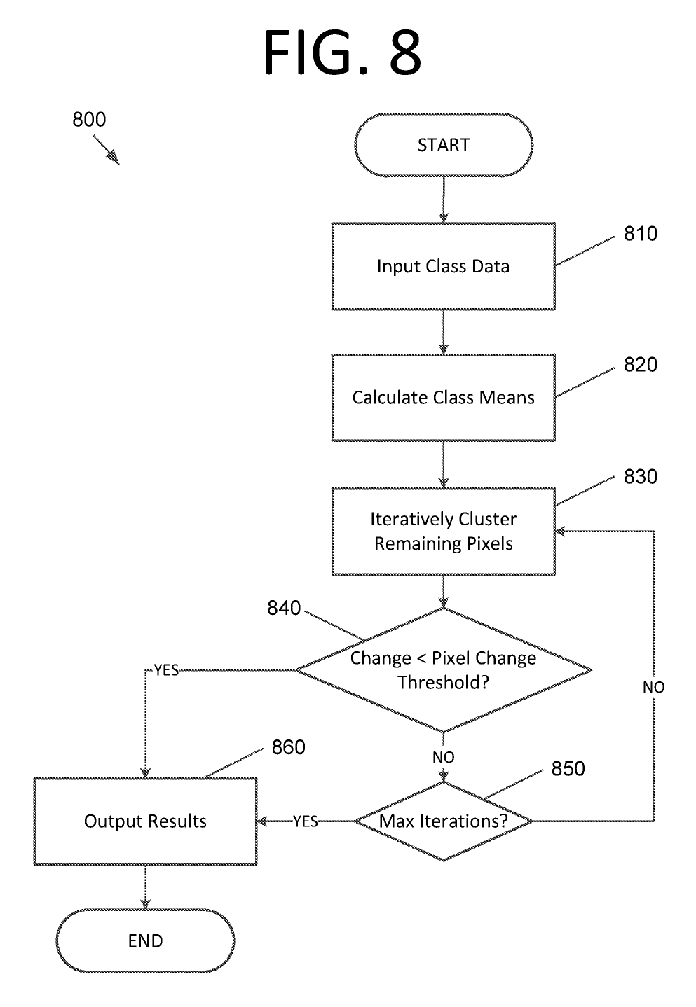

FIG. 8 illustrates a flowchart 800 of an Iterative Self-Organizing Data Analysis Technique Algorithm (ISODATA) used for unsupervised learning, according to an embodiment of the present invention. The ISODATA algorithm may be performed, for example, by a computer system such as system 100 of FIG. 1. First, class data generated by a supervised algorithm is input at 810. The class data may include spectral/structural signature information. The ISODATA algorithm then calculates class means evenly distributed in the data at 820. Next, the ISODATA algorithm iteratively clusters remaining pixels at 830. Each iteration recalculates means and reclassifies pixels with respect to the newly calculated means. If the number of pixels in each class changes by less than the selected pixel change threshold at 840, or if the maximum number of iterations has been reached at 850, the results are output at 860 and the process ends. Otherwise, the process continues back to iteratively clustering the remaining pixels at 830.

Some embodiments of the present invention use a supervised algorithm to identify and separate a class of objects of interest and then an unsupervised algorithm to identify certain characteristics about the objects identified by the supervised algorithm. This approach allows large quantities of map data that are either inconvenient or impossible for individuals to review to be analyzed effectively and accurately. Embodiments of the present invention have many uses in interpreting map data, such as identifying certain objects, places or features on a map and separating these features from other features. The identified features may then be analyzed to determine various characteristics about the objects, such as their type, number, density and state. Applications include, but are not limited to, assessing tree health, assessing crops, assessing fire damage, assessing land use, etc.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer program embodied on a non-transitory computer-readable medium, the program configured to cause a processor to:
execute a supervised algorithm on a set of map data to separate a class of objects of interest from other objects;
execute an unsupervised algorithm to identify different types or states of individual objects within the class of objects of interest identified by the supervised algorithm; and
cause results produced by the unsupervised algorithm to be stored on a non-transitory storage medium.

2. The computer program of claim 1, wherein the program is configured to cause the processor to determine warning signs of tree mortality, perform crop assessment, assess land use, or perform fire damage assessment.

3. The computer program of claim 1, wherein the supervised algorithm comprises a Minimum Distance algorithm and the unsupervised algorithm comprises an ISODATA algorithm.

4. The computer program of claim 1, wherein the supervised algorithm uses both positive and negative examples to identify, and maximize differences between, two classes, while the unsupervised algorithm uses only the class with positive examples or the class with negative examples.

5. The computer program of claim 1, wherein the map data analyzed by the program is satellite imagery data.

6. The computer program of claim 1, wherein the supervised algorithm is configured to separate trees from other terrestrial objects and the unsupervised algorithm is configured to assess tree health.

7. An apparatus, comprising:
physical memory and a processor configured to read information from, and write information to, the physical memory, wherein
the processor is configured to
execute a supervised algorithm on a set of map data to identify and separate trees from other terrestrial objects,
execute an unsupervised algorithm, using tree data produced by the supervised algorithm, to assess tree health,
determine warning signs of tree mortality based on results produced by the unsupervised algorithm, and
cause data pertaining to the warning signs of tree mortality to be stored on the physical memory.

8. The apparatus of claim 7, wherein the processor is configured to determine the warning signs of tree mortality by identifying levels of stress on individual trees.

9. The apparatus of claim 8, wherein the identifying of levels of stress on individual trees comprises identifying whether each tree is healthy, stressed or dead.

10. The apparatus of claim 7, wherein the supervised algorithm comprises a Minimum Distance algorithm and the unsupervised algorithm comprises an ISODATA algorithm.

11. The apparatus of claim 7, wherein the unsupervised algorithm is further configured to determine different types of individual trees based on profiles for tree types.

12. The apparatus of claim 7, wherein the processor is configured to classify, using the supervised algorithm, all pixels to the closest region of interest class, unless a standard deviation or distance threshold is exceeded.

13. The apparatus of claim 13, wherein the supervised algorithm employs a spectral signature, a structural signature, or both, to classify objects in the map data.

14. A computer-implemented method, comprising:
executing, via a processor, a supervised algorithm on a set of map data to identify and separate a class of objects of interest from other objects;
executing, via the processor, an unsupervised algorithm to identify different types or states of individual objects within the class of objects of interest identified by the supervised algorithm; and
storing results produced by the unsupervised algorithm on a non-transitory storage medium, wherein
the supervised and unsupervised algorithms use three color bands to separate the class of objects of interest and to determine the types or states of the individual objects within the class of objects of interest.

15. The computer-implemented method of claim 14, wherein the three color bands are red, green and blue.

16. The computer-implemented method of claim 14, wherein the supervised algorithm comprises a Minimum Distance algorithm and the unsupervised algorithm comprises an ISODATA algorithm.

17. The computer-implemented method of claim 14, wherein the supervised algorithm is configured to separate trees from other terrestrial objects and the unsupervised algorithm is configured to assess tree health.

18. The computer-implemented method of claim 17, wherein the unsupervised algorithm is further configured to determine different types of individual trees based on profiles for tree types.

19. The computer-implemented method of claim 18, wherein the supervised algorithm classifies all pixels to the closest region of interest class, unless a standard deviation or distance threshold is exceeded.

20. The computer-implemented method of claim 19, wherein the supervised algorithm employs a spectral signature, a structural signature, or both, to classify objects in the map data.
